(19) United States
(12) Patent Application Publication
(10) Pub. No.: US 2004/0218493 A1
(43) Pub. Date: Nov. 4, 2004

(54) Method for detecting an unbalanced optical disc in an opticl disc drive

(76) Inventors: Jen-Yu Hsu, Taipei City (TW); Hsiang-Yi Fu, Taipei City (TW); Tun-Chieh Lee, Taipei City (TW); Fu-Hsiang Chen, Taipei City (TW); Yao-Chou Tsai, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/832,202

(22) Filed: Apr. 26, 2004

(30) Foreign Application Priority Data
Apr. 30, 2003 (TW) 92110134

(51) Int. Cl. G11B 7/09; G11B 7/095

(52) U.S. Cl. 369/53.14; 369/44.32; 369/53.13

(57) ABSTRACT

A method for detecting an unbalanced optical disc in an optical disc drive. The unbalanced optical disc is detected by a pick-up head of the optical disc drive to obtain a tracking error signal. A first track-across number at which the pick-up head travels on the unbalanced optical disc is determined when the unbalanced optical disc rotates at a first rotational speed. A second track-across number at which the pick-up head travels on the unbalanced optical disc is determined when the unbalanced optical disc rotates at a second rotational speed. The first track-across number and second track-across number are computed to obtain a resulting value. The unbalanced level of the unbalanced optical disc is determined according to the resulting value.

### BACKGROUND OF THE INVENTION

1. Field of the Invention

The present invention relates to a method for detecting an unbalanced optical disc in an optical disc drive, and in particular to a method that detects an unbalanced optical disc by means of determining the track-across number thereof according to a tracking error signal.

2. Description of the Related Art

When an optical disc drive operates at high speed, an unbalanced optical disc (the mass center of an optical disc is not located in the center thereof) therein generally vibrates violently, causing noise, accelerating mechanical fatigue of the optical disc drive and reducing the lifespan of the optical disc drive. Further, the unbalanced optical disc may even scrape or damage the object lens of a pick-up head in the optical disc drive. Thus, vibration control of an unbalanced optical disc is important.

Generally speaking, when an optical disc becomes unbalanced, the operating speed of the optical disc drive must be reduced to stop vibration. Namely, the operating speed of the optical disc drive must be reduced to stabilize the optical disc before it can be accessed. Additionally, because different optical discs have different unbalanced levels, it is difficult to determine a proper operating speed for the optical disc drive. Accordingly, the unbalanced level of the unbalanced optical disc must be accurately detected, such that the optical disc drive can automatically and properly adjust the operating speed thereof according to the unbalanced level. The access speed of the optical disc drive can then be effectively enhanced.

Nevertheless, conventional optical disc drives cannot determine the optimum operating speed thereof according to the unbalanced level of the unbalanced optical disc.

R.O.C. Patent No. 389885 discloses a method of measuring the deviation of an unbalanced optical disc based on the central hole thereof. Namely, the method calculates the deviation value of the central hole of the unbalanced optical disc. The method, however, cannot obtain the actual unbalanced level of the unbalanced optical disc.

R.O.C. Patent No. 337580 discloses a detection device to detect radial vibration of the unbalanced optical disc. Similarly, the detection device cannot obtain the actual unbalanced level of the unbalanced optical disc.

Hence, there is a need to provide a method to detect the actual unbalanced level of the unbalanced optical disc to determine an optimum operating speed for the optical disc drive.

### SUMMARY OF THE INVENTION

Accordingly, an object of the invention is to provide a method to detect an unbalanced optical disc in an optical disc drive. The method of the invention obtains the actual unbalanced level of the unbalanced optical disc by means of determining a track-across number at which a pick-up head of the optical disc drive travels on the unbalanced optical disc due to vibration. Then, the optical disc drive can operate at an optimum access speed according to the actual unbalanced level of the unbalanced optical disc. Moreover, because the method of the invention directly uses the pick-up head to measure the track-across number when servo focus of the optical disc drive is performed, the optical disc drive does not require any additional detection device and can rapidly detect the unbalanced level of the unbalanced optical disc. Thus, the operation of the optical disc drive can be effectively enhanced.

The method of the invention comprises the following steps. The unbalanced optical disc is detected by a pick-up head of the optical disc drive to obtain a tracking error signal. A first track-across number at which the pick-up head travels on the unbalanced optical disc is determined when the unbalanced optical disc rotates at a first rotational speed. A second track-across number at which the pick-up head travels on the unbalanced optical disc is determined when the unbalanced optical disc rotates at a second rotational speed. The first track-across number and second track-across number are computed to obtain a resulting value. The unbalanced level of the unbalanced optical disc is determined according to the resulting value.

Preferably, the method further comprises a step of adjusting the rotational speed of the unbalanced optical disc according to the unbalanced level.

Accordingly, the unbalanced optical disc vibrates slightly when rotating at the first rotational speed.

The first rotational speed of the unbalanced optical disc corresponds to 10× access speed (1500 KB/sec) of the pick-up head.

The first track-across number is determined according to the tracking error signal and a radio frequency ripple signal.

The optical disc drive vibrates when the unbalanced optical disc rotates at the second rotational speed.

The second rotational speed of the unbalanced optical disc corresponds to 20× to 24× access speed (3000 KB/sec to 3600 KB/sec) of the pick-up head.

The second track-across number is determined according to the tracking error signal and a radio frequency ripple signal.

The resulting value is the difference between the first track-across number and the second track-across number.

The steps are performed when the pick-up head and unbalanced optical disc operate in a non-tracked condition.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a diagram showing the waveforms of a radio frequency ripple signal and tracking error signal; and

FIG. 2 is a flowchart showing the steps of the method of the invention of detecting an unbalanced optical disc in an optical disc drive.

### DETAILED DESCRIPTION OF THE INVENTION

The method of the invention detects the unbalanced level of an unbalanced optical disc by means of determining the track-across number at which the object lens of a pick-up head travels on the unbalanced optical disc to allow the optical disc drive to operate at an optimum access speed.

When the unbalanced optical disc is positioned in the optical disc drive, the unbalanced optical disc rotates at a first rotational speed (lower rotational speed) ω1 and the pick-up head performs servo focus on the unbalanced optical disc. Specifically, the unbalanced optical disc vibrates slightly when rotating at the first rotational speed ω1. The first rotational speed ω1 is approximately 2000 rpm and corresponds to 10× access speed (1500 KB/sec) of the pick-up head. At this point, the pick-up head operates in a non-tracked condition and thereby track-across phenomenon exists between the pick-up head and the unbalanced optical disc.

Additionally, the optical disc drive performs a normalization action according to signals from the pick-up head under the non-tracked condition and after the pick-up head performs servo focus. A tracking error signal and a radio frequency ripple signal can then be obtained. For example, the tracking error signal may be obtained using a three-beam method to detect track vibration of the unbalanced optical disc. Specifically, the tracking error signal may be obtained by other conventional methods.

The optical disc drive determines the track-across number of the pick-up head. Namely, the optical disc drive can obtain the track-across number of the pick-up head according to the tracking error signal. Specifically, the higher the operating speed of the optical disc drive or the rotational speed of the unbalanced optical disc, the greater the vibration of the unbalanced optical disc and the pick-up head. The vibration level of the unbalanced optical disc can be obtained according to the tracking error signal before the pick-up head tracks on the unbalanced optical disc.

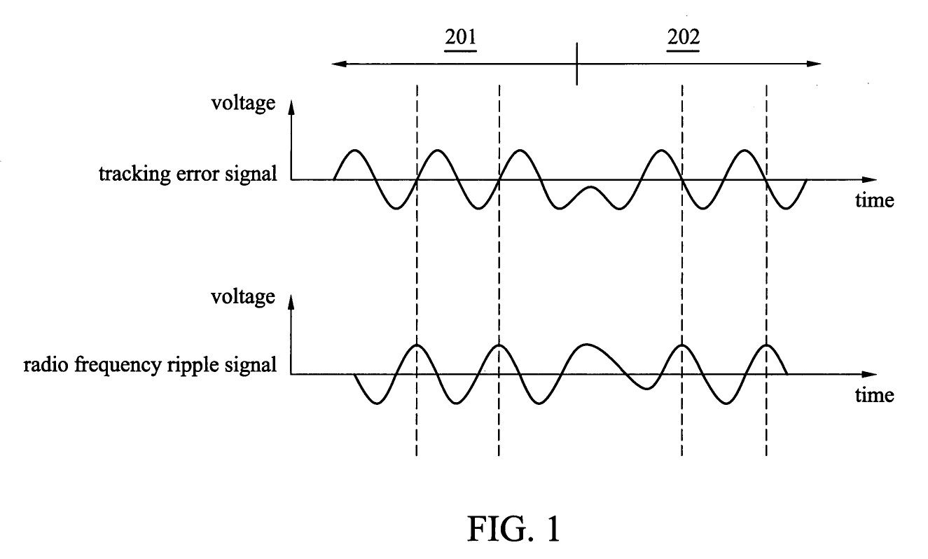

After the pick-up head performs servo focus and before the pick-up head tracks on the unbalanced optical disc, the unbalanced optical disc rotates at the first rotational speed ω1. As shown in FIG. 1, the track-across number of the object lens of the pick-up head can be determined according to the tracking error signal and radio frequency ripple signal. The sliding direction of the unbalanced optical disc can be measured according to the phase difference between the tracking error signal and the radio frequency ripple signal. According to the tracking error signal and radio frequency ripple signal, the sliding direction (inward direction 202 or outward direction 201) of the unbalanced optical disc can be obtained. When the unbalanced optical disc slides in the outward direction 201, the phase of the radio frequency ripple signal is prior to that of the tracking error signal by 90 degrees. When the unbalanced optical disc slides in the inward direction 202, the phase of the tracking error signal is prior to that of the radio frequency ripple signal by 90 degrees. Specifically, a cycle of the tracking error signal means that the unbalanced optical disc slides inward or outward by one track. Accordingly, the sliding range of the tracks on the unbalanced optical disc can be obtained by counting the cycles of the tracking error signal. The track-across number of the pick-up head can then be obtained. Namely, a first track-across number N1 of the pick-up head can then be determined according to the tracking error signal and radio frequency ripple signal when the unbalanced optical disc rotates in a cycle and at the first rotational speed ω1.

Accordingly, because the object lens of the pick-up head and unbalanced optical disc vibrates relatively, the track-across number is a relative value. Specifically, the object lens of the pick-up head and unbalanced optical disc vibrate or move simultaneously. When the unbalanced optical disc rotates, the vibration generated by the unbalanced optical disc is transmitted to the whole optical disc drive, thus causing vibration of the spindle and object lens of the pick-up head of the optical disc drive.

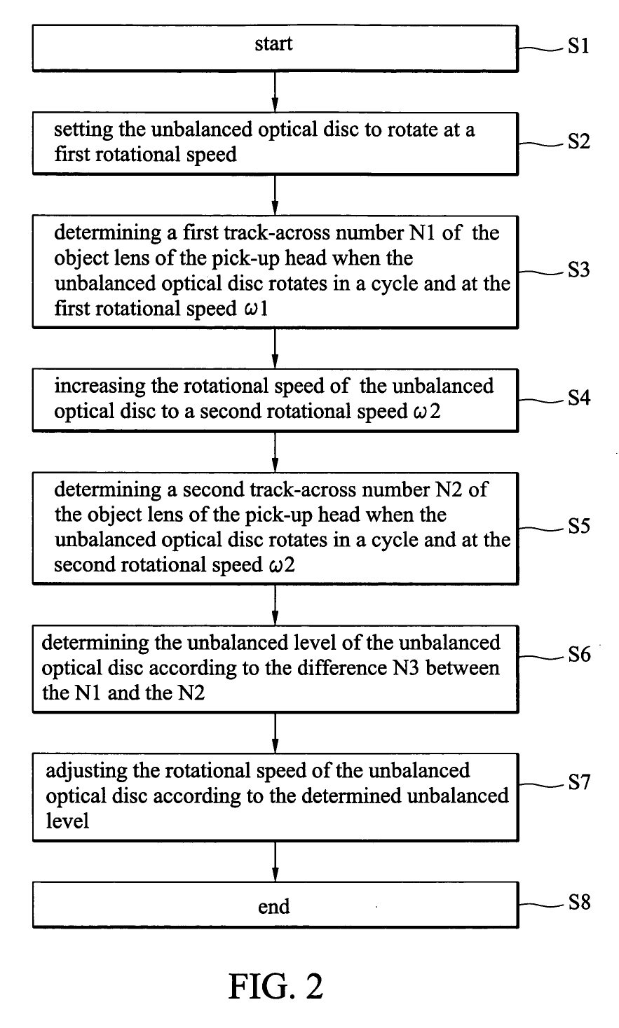

Referring to FIG. 2, the rotational speed of the unbalanced optical disc is set to the first rotational speed ω1 that the unbalanced optical disc vibrates slightly (S1). The first track-across number N1 of the pick-up head is determined when the unbalanced optical disc rotates in a cycle and at the first rotational speed ω1 (S3), and then the rotational speed of the unbalanced optical disc is increased to a second rotational speed ω2 (S4). The second rotational speed ω2 is approximately 4000-4800 rpm and corresponds to 20×-24× access speed (3000-3600 KB/sec) of the pick-up head. At this point, another tracking error signal and radio frequency ripple signal can be obtained in the same manner as described above. A second track-across number N2 of the pick-up head can be determined according to the tracking error signal and radio frequency ripple signal when the unbalanced optical disc rotates in a cycle and at the second rotational speed ω2 (S5).

The unbalanced level of the unbalanced optical disc can be determined by computing the first track-across number N1 and second track-across number N2 to obtain a resulting value N3 (S6). For example, the resulting value N3 is the difference between the first track-across number N1 and the second track-across number N2. The larger the resulting value N3, the higher the unbalanced level of the unbalanced optical disc. On the other hand, the smaller the resulting value N3, the lower the unbalanced level of the unbalanced optical disc.

According to the determined unbalanced level of the unbalanced optical disc, the optical disc drive can be adjusted to operate at an optimum (highest) speed without causing violent vibration of the unbalanced optical disc (S7). Thus, damage to the unbalanced optical disc and optical disc drive can be prevented during access.

Accordingly, the method of the invention detects the unbalanced level according to two different track-across numbers under two different rotational speeds of an optical disc. The track-across number depends on the unbalanced optical disc and pick-up head. In another aspect, an eccentric optical disc on which the tracks are arranged eccentrically or the vibration of the object lens of the pick-up head increase the track-across number. Since the method of the invention detects the unbalanced level according to the different track-across numbers under different rotational speeds of the optical disc, the eccentric optical disc and unbalanced optical disc are easily distinguished. Namely, because the optical disc rotates at the first rotational speed ω1 (low rotational speed), the object lens of the pick-up head vibrates slightly. If the track-across number is large when the optical disc rotates at the first rotational speed ω1 (low rotational speed), the optical disc is an eccentric optical disc. Since the object lens of the pick-up head vibrates violently when the unbalanced optical disc rotates at the high rotational speed, the resulting value N3 for the eccentric optical disc is smaller than that for the unbalanced optical disc. Thus, incorrect discrimination between the eccentric optical disc and the unbalanced optical disc can be prevented.

Accordingly, the steps of the present method are performed after the pick-up head performs servo focus and before the pick-up head tracks on the unbalanced optical disc. Thus, the unbalanced level of the unbalanced optical disc is accurately detected.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for detecting an unbalanced optical disc in an optical disc drive, comprising the steps of:
detecting the unbalanced optical disc by means of a pick-up head of the optical disc drive to obtain a tracking error signal;
determining a first track-across number at which the pick-up head travels on the unbalanced optical disc when the unbalanced optical disc rotates at a first rotational speed;
determining a second track-across number at which the pick-up head travels on the unbalanced optical disc when the unbalanced optical disc rotates at a second rotational speed;
computing the first track-across number and second track-across number to obtain a resulting value; and
determining the unbalanced level of the unbalanced optical disc according to the resulting value.

2. The method as claimed in claim 1, further comprising a step of:
adjusting the rotational speed of the unbalanced optical disc according to the unbalanced level.

3. The method as claimed in claim 1, wherein the unbalanced optical disc vibrates slightly when rotating at the first rotational speed.

4. The method as claimed in claim 1, wherein the first rotational speed of the unbalanced optical disc corresponds to 10× access speed (1500 KB/sec) of the pick-up head.

5. The method as claimed in claim 1, wherein the first track-across number is determined according to the tracking error signal and a radio frequency ripple signal.

6. The method as claimed in claim 1, wherein the optical disc drive vibrates when the unbalanced optical disc rotates at the second rotational speed.

7. The method as claimed in claim 1, wherein the second rotational speed of the unbalanced optical disc corresponds to 20× to 24× access speed (3000 KB/sec to 3600 KB/sec) of the pick-up head.

8. The method as claimed in claim 1, wherein the second track-across number is determined according to the tracking error signal and a radio frequency ripple signal.

9. The method as claimed in claim 1, wherein the resulting value is the difference between the first track-across number and the second track-across number.

10. The method as claimed in claim 1, wherein the steps are performed when the pick-up head and unbalanced optical disc operate under a non-tracked condition.
